(19) United States
(12) Patent Application Publication
(10) Pub. No.: US 2021/0200520 A1
(43) Pub. Date: Jul. 1, 2021

(54) PROGRAM PREPARATION SYSTEM, PROGRAM PREPARATION DEVICE, AND ROBOT SYSTEM

(71) Applicant: SEIKO EPSON CORPORATION, Tokyo (JP)

(72) Inventor: Yoshiki NAGASHIMA, SHIOJIRI-SHI (JP)

(21) Appl. No.: 17/131,794

(22) Filed: Dec. 23, 2020

(30) Foreign Application Priority Data
Dec. 25, 2019 (JP) 2019-233820

(51) Int. Cl. G06F 8/41; G06F 9/48; G06F 11/30; G06F 11/34; G05B 19/4155; B25J 11/00; B25J 15/08

(52) U.S. Cl. CPC G06F 8/44; G06F 9/48; G06F 11/302; G05B 2219/50391; G05B 19/4155; B25J 11/005; B25J 15/08; G06F 11/3495

(57) ABSTRACT

A program preparation system includes: a display unit displaying a first task input section to which a content of a first task to be executed by a target device is inputted and a second task input section to which a content of a second task to be executed by the target device is inputted, the second task being different from the first task; an intermediate code generation unit generating an intermediate code, using information inputted to the first task input section and information inputted to the second task input section; and a program conversion unit converting the intermediate code into a multitasking program causing the target device to execute the first task and the second task.

The present application is based on, and claims priority from JP Application Serial Number 2019-233820, filed Dec. 25, 2019, the disclosure of which is hereby incorporated by reference herein in its entirety.

### BACKGROUND

### 1. Technical Field

The present disclosure relates to a program preparation system, a program preparation device, and a robot system.

### 2. Related Art

JP-A-2000-055644 describes a system having a transport device, a machine tool, an inline measurement device, and an integrated control device controlling these elements in an integrated manner via sequence control. In this system, the integrated control device executes in parallel a measurement task of measuring a dimension of a workpiece by the inline measurement device and an abnormality monitoring task of monitoring the presence/absence of an abnormality in each part.

A lot of skill is needed to prepare a program to achieve multitasking in which a plurality of tasks are executed simultaneously and in parallel as in the foregoing system. Therefore, a technique that enables easier preparation of a program to achieve multitasking is desired.

### SUMMARY

According to a first aspect of the disclosure, a program preparation system is provided. The program preparation system includes: a display unit displaying a first task input section to which a content of a first task to be executed by a target device is inputted and a second task input section to which a content of a second task to be executed by the target device is inputted, the second task being different from the first task; an intermediate code generation unit generating an intermediate code, using information inputted to the first task input section and information inputted to the second task input section; and a program conversion unit converting the intermediate code into a multitasking program causing the target device to execute the first task and the second task.

According to a second aspect of the disclosure, a program preparation device is provided. The program preparation device includes: a display unit displaying a first task input section to which a content of a first task to be executed by a target device is inputted and a second task input section to which a content of a second task to be executed by the target device is inputted, the second task being different from the first task; an intermediate code generation unit generating an intermediate code, using information inputted to the first task input section and information inputted to the second task input section; and a program conversion unit converting the intermediate code into a multitasking program causing the target device to execute the first task and the second task.

According to a third aspect of the disclosure, a robot system is provided. The robot system includes: a program preparation system including a display unit displaying a first task input section to which a content of a first task to be executed by a target device is inputted and a second task input section to which a content of a second task to be executed by the target device is inputted, the second task being different from the first task, an intermediate code generation unit generating an intermediate code, using information inputted to the first task input section and information inputted to the second task input section, and a program conversion unit converting the intermediate code into a multitasking program causing the target device to execute the first task and the second task; and a robot operating based on the multitasking program generated by the program preparation system.

### BRIEF DESCRIPTION OF THE DRAWINGS

FIG. 1 is a block diagram showing a schematic configuration of a robot system according to a first embodiment.

FIG. 2 is a flowchart showing the content of a program generation process.

FIG. 3 is an explanatory view showing an example of a first task input section.

FIG. 4 is an explanatory view showing an example of a second task input section.

FIG. 5 is an explanatory view showing an example of a processing content input section.

FIG. 6 is an explanatory view showing an example of the second task input section in the state where processing is added.

FIG. 7 is an explanatory view showing an example of an occurrence condition input section.

FIG. 8 is an explanatory view showing an example of the second task input section in the state where an occurrence condition is added.

FIG. 9 is a block diagram showing a schematic configuration of a robot system according to another embodiment.

### DESCRIPTION OF EXEMPLARY EMBODIMENTS

### A. First Embodiment

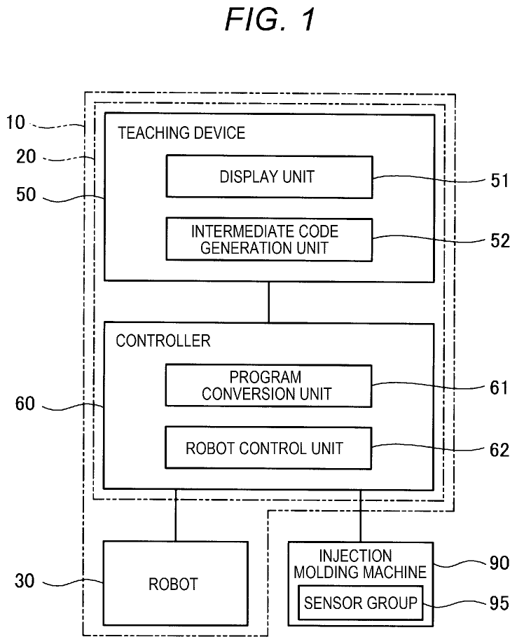

FIG. 1 is a block diagram showing a schematic configuration of a robot system 10 according to a first embodiment. The robot system 10 has a program preparation system 20 and a robot 30. The program preparation system 20 has a teaching device 50 and a controller 60. In this embodiment, an injection molding machine 90 is coupled as an external device to the controller 60.

The robot 30 is formed of a vertical articulated robot. In this embodiment, the robot 30 takes out a molded product from a metal mold in the injection molding machine 90 and places the molded product that is taken out, at a predetermined position. The robot 30 has a gripper installed at a distal end part and grips the molded product with the gripper. The robot 30 is driven under the control of the controller 60. The robot 30 may be formed of a horizontal articulated robot or the like, instead of a vertical articulated robot.

The teaching device 50 is formed of a computer having one or a plurality of processors, a main storage device, and an input/output interface inputting and outputting a signal from and to outside. The teaching device 50 performs various functions by having the processor execute a program or command read onto the main storage device. The teaching device 50 is configured to be able to communicate with the controller 60 via wired communication or wireless communication. The teaching device 50 may be formed of a tablet terminal, teach pendant or the like, instead of a computer.

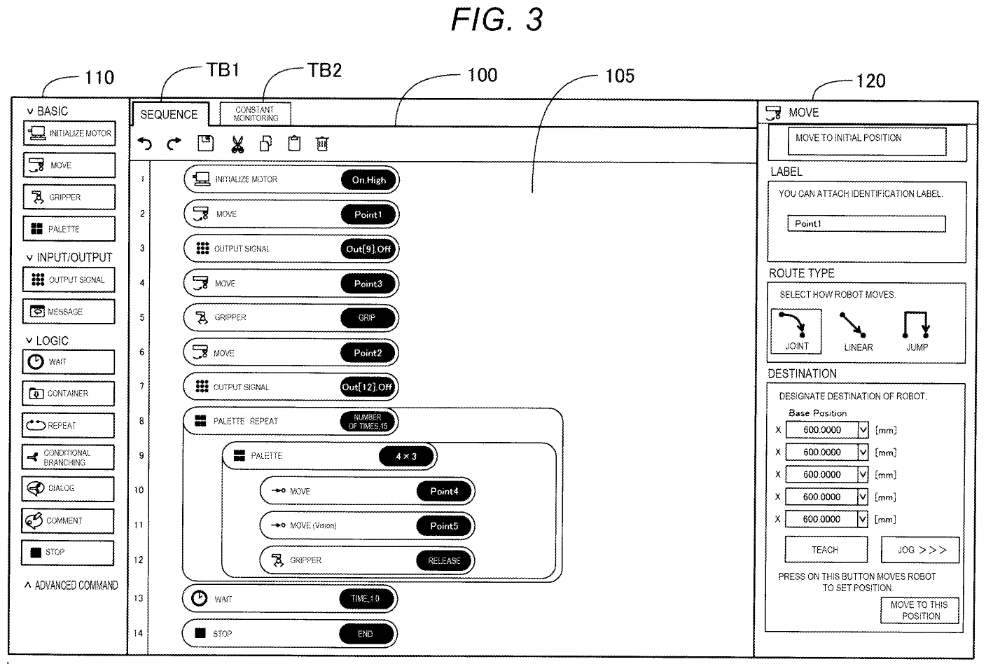

The teaching device 50 has a display unit 51 and an intermediate code generation unit 52. The display unit 51 is formed of a display. The display unit 51 may be formed of a touch panel. On the display unit 51, a first task input section 100 and a second task input section 200 described later with reference to FIGS. 3 to 8 are displayed. The first task input section 100 and the second task input section 200 are GUIs (graphical user interfaces) to input an operation to be achieved by the robot 30. The content of a first task is inputted to the first task input section 100. The content of a second task that is different from the first task is inputted to the second task input section 200. The intermediate code generation unit 52 generates an intermediate code, using information inputted via the first task input section 100 and the second task input section 200. The generated intermediate code is transmitted to a program conversion unit 61 of the controller 60.

The controller 60 is formed of a computer having one or a plurality of processors, a main storage device, and an input/output interface inputting and outputting a signal from and to outside. The controller 60 performs various functions by having the processor execute a program or command read onto the main storage device. To the controller 60, the robot 30 and the injection molding machine 90 are coupled communicatively via wired communication or wireless communication. The controller 60 may be formed of a combination of a plurality of circuits to achieve at least a part of the functions, instead of being formed of a computer.

The controller 60 has the program conversion unit 61 and a robot control unit 62. The program conversion unit 61 generates a multitasking program to execute the first task and the second task simultaneously and in parallel, using the intermediate code supplied from the intermediate code generation unit 52. The generated multitasking program is transmitted to the robot control unit 62. The robot control unit 62 controls the robot 30, using the multitasking program supplied from the program conversion unit 61.

The injection molding machine 90 is formed of an injection device, a metal mold, and a mold clamping device. The injection molding machine 90 injects a molten resin into the metal mold from the injection device and thus forms a molded product. The metal mold is opened and closed by the mold clamping device. The injection device and the mold clamping device are driven under the control of the controller 60. The injection molding machine 90 has a sensor group 95. The sensor group 95 includes a pressure sensor acquiring the pressure inside the metal mold, and a temperature sensor acquiring the temperature of the metal mold. Information about the pressure and temperature acquired by the sensor group 95 is transmitted to the controller 60.

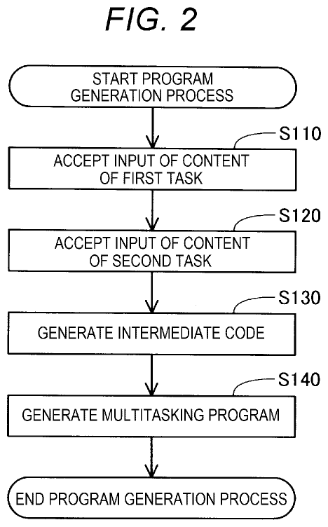

FIG. 2 is a flowchart showing the content of a program generation process to generate a multitasking program. First, in step S110, the user inputs the content of the first task via the first task input section 100 displayed on the display unit 51. At this time, the teaching device 50 accepts the input of the first task. In this embodiment, the content of a task to cause the robot 30 to implement the operation of taking out a molded product from the metal mold in the injection molding machine 90 and placing the molded product that is taken out at a predetermined position is inputted as the first task.

Next, in step S120, the user inputs the content of the second task via the second task input section 200 displayed on the display unit 51. At this time, the teaching device 50 accepts the input of the second task. The second task is a task executed simultaneously and in parallel with the first task. In this embodiment, a task to constantly monitor whether an abnormality has occurred in the injection molding machine 90 or not during the execution of the first task and to cause the robot 30 or the like to implement a predetermined operation when it is determined that an abnormality has occurred, is inputted as the second task. The order of steps S110 and S120 may be reversed.

Subsequently, in step S130, the intermediate code generation unit 52 generates an intermediate code, using the information inputted to the first task input section 100 and the information inputted to the second task input section 200. In this embodiment, the intermediate code generation unit 52 generates an intermediate code expressed in the JSON format. The intermediate code generation unit 52 may generate an intermediate code expressed in other formats instead of the JSON format. The generated intermediate code is transmitted to the program conversion unit 61.

In step S140, the program conversion unit 61 generates a multitasking program expressed in a language that can be interpreted by the robot control unit 62, using the intermediate code acquired from the intermediate code generation unit 52. In this embodiment, the program conversion unit 61 generates a multitasking program expressed in the SPEL format. The program conversion unit 61 may generate a multitasking program expressed in other formats instead of the SPEL format. The program conversion unit 61 can generate a multitasking program, for example, by converting the intermediate code using a pre-installed conversion program. A multitasking program is thus generated via the above process. The generated multitasking program is transmitted to the robot control unit 62. Subsequently, the robot control unit 62 controls the robot 30, using the generated multitasking program.

FIG. 3 is an explanatory view showing an example of the first task input section 100. In response to a predetermined operation on the teaching device 50 carried out by the user, the teaching device 50 causes the display unit 51 to display the first task input section 100. The first task input section 100 has a first operation flow display area 105, a first operation selection area 110, and a first detail input area 120. In the first operation flow display area 105, a first operation flow successively showing a plurality of operations to be implemented by the robot 30 in normal times is displayed.

In the first operation selection area 110, a list of types of operation that can be implemented by the robot 30 is displayed. In the first operation selection area 110, types of operation such as “initialize motor”, “move”, and “gripper” are displayed. “Initialize motor” represents an operation of initializing a servo motor forming a joint part of the robot 30. “Move” represents an operation of moving an arm part in such a way that the distal end part of the robot 30 moves to designated coordinates. “Gripper” represents an operation of the gripper installed at the distal end part of the robot 30. The user can select a type of operation to be implemented by the robot 30 from the list displayed in the first operation selection area 110. The operation of the selected type is added to the first operation flow displayed in the first operation flow display area 105.

The content displayed in the first detail input area 120 changes according to the type of operation selected from the first operation selection area 110. In the example shown in FIG. 3, “move” is selected as the type of operation and an input space for the coordinates of the destination of the distal end part or the like is displayed in the first detail input area 120. The user can input a detailed content of the operation of the selected type via the first detail input area 120. By repeating the above operation, the user can prepare the first operation flow. The user can edit and delete the prepared first operation flow. As the first operation flow is prepared, the content of the first task is inputted to the first task input section 100.

In response to the selection of a second tab TB2 by the user, the second task input section 200 is displayed on the display unit 51. When a first tab TB1 is selected in the state where the second task input section 200 is displayed on the display unit 51, the first task input section 100 is displayed again on the display unit 51.

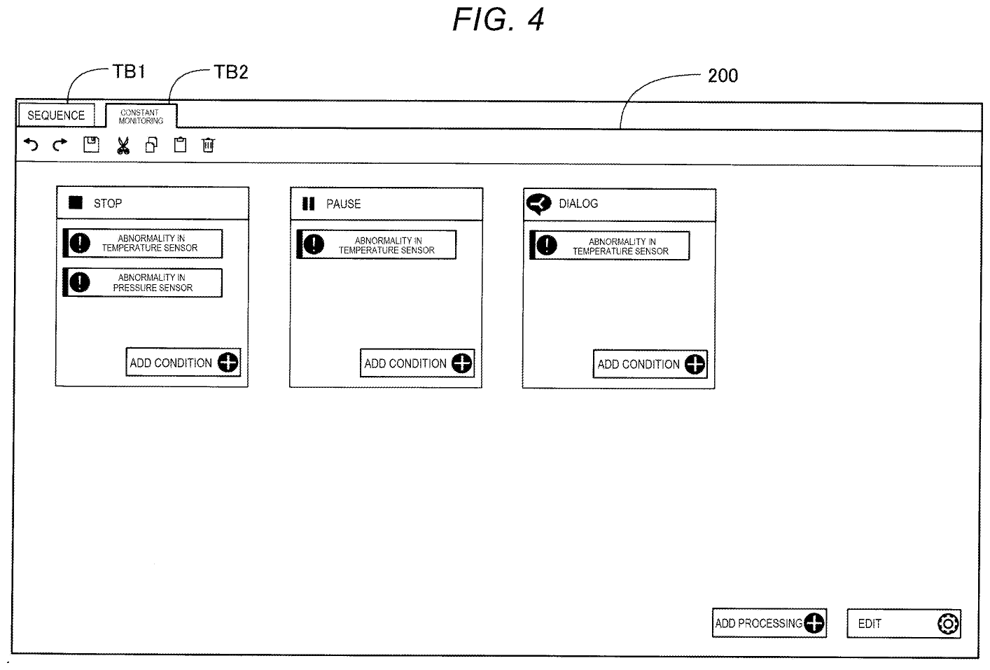

FIG. 4 is an explanatory view showing an example of the second task input section 200. In the second task input section 200, a processing content input section 201 and an occurrence condition input section 202 are displayed. To the occurrence condition input section 202, an occurrence condition indicating that an abnormality has occurred in at least one of the robot system 10 and the injection molding machine 90 coupled to the robot system 10 is inputted. To the processing content input section 201, the content of processing to be executed by the robot control unit 62 when the occurrence condition is met is inputted.

FIG. 4 shows an example of the second task input section 200 where three kinds of processing, “stop”, “pause”, and “dialog”, are inputted. “Stop” is processing of a content to the effect that the first operation flow implemented by the robot 30 is to be ended. In the example shown in FIG. 4, “abnormality in temperature sensor” and “abnormality in pressure sensor” are inputted as the occurrence condition for “stop”. “Abnormality in temperature sensor” indicates that the occurrence of an abnormality is detected by the temperature sensor provided in the injection molding machine 90. “Abnormality in pressure sensor” indicates that the occurrence of an abnormality is detected by the pressure sensor provided in the injection molding machine 90.

“Pause” is processing of temporarily stopping the first operation flow implemented by the robot 30. The first operation flow implemented by the robot 30 can be resumed later. “Abnormality in temperature sensor” is inputted as the occurrence condition for “pause”. As the occurrence condition of “abnormality in temperature sensor” for “pause”, a different condition from the occurrence condition of “abnormality in temperature sensor” for “stop” can be inputted.

“Dialog” is processing of causing the display unit 51 to display a dialog notifying the occurrence of an abnormality. “Abnormality in temperature sensor” is inputted as the occurrence condition for “dialog”. As the occurrence condition of “abnormality in temperature sensor” for “dialog”, a different condition from the occurrence condition of “abnormality in temperature sensor” for “stop” and the occurrence condition of “abnormality in temperature sensor” for “pause” can be inputted. In some cases, the display unit 51 is referred to as a notification unit. The notification of the occurrence of an abnormality may be carried out by other measures than causing the display unit 51 to display a dialog. For example, a buzzer coupled to the controller 60 may be provided in the robot system 10, and the buzzer may generate a warning sound to notify the occurrence of an abnormality. In this case, the buzzer is referred to as a notification unit. Also, a warning lamp coupled to the controller 60 may be provided in the robot system 10, and the warning lamp may turn on to notify the occurrence of an abnormality. In this case, the warning lamp is referred to as a notification unit.

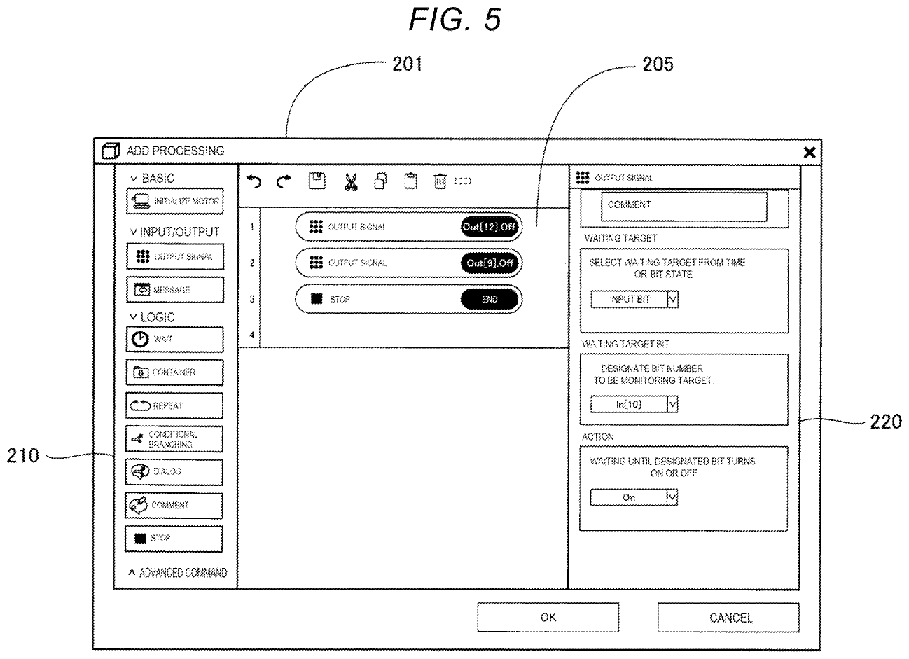

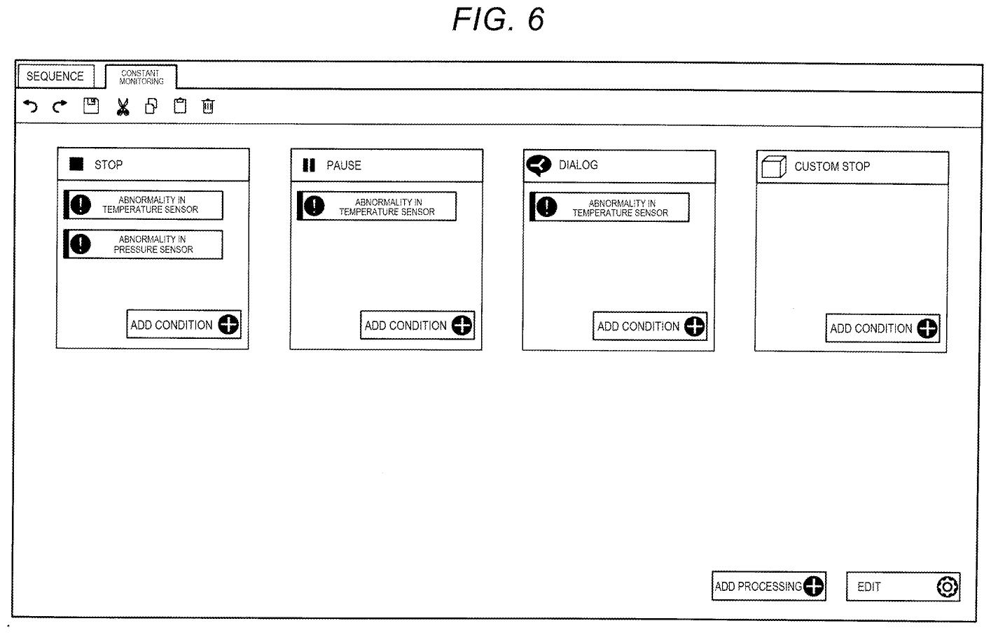

FIG. 5 is an explanatory view showing an example of the processing content input section 201. FIG. 6 is an explanatory view showing an example of the second task input section 200 in the state where processing is added. FIG. 6 shows the second task input section 200 in the state where processing is added from the state shown in FIG. 4. The processing content input section 201 is displayed on the second task input section 200 in response to the selection by the user of an “add processing” button provided in the second task input section 200.

The processing content input section 201 has a second operation flow display area 205, a second operation selection area 210, and a second detail input area 220. In the second operation flow display area 205, a second operation flow successively showing a plurality of operations to be implemented by the robot 30 when an abnormality occurs is displayed. The other parts of the configuration and functions of the second operation flow display area 205 are the same as those of the first operation flow display area 105. The configuration and functions of the second operation selection area 210 are the same as those of the first operation selection area 110. The configuration and functions of the second detail input area 220 are the same as those of the first detail input area 120.

In the example shown in FIG. 5, the second operation flow of a content to the effect that the signal outputted from the 12^{th} output port of the controller 60 is to be turned off, that the signal outputted from the 9^{th} output port of the controller 60 is to be turned off, and that the first operation flow implemented by the robot 30 is to be stopped subsequently. In response to the selection by the user of an “OK” button provided in the processing content input section 201, the content of the processing inputted to the processing content input section 201 is inputted to the second task input section 200. When a “cancel” button provided in the processing content input section 201 is selected by the user, the content of the processing inputted to the processing content input section 201 is discarded instead of being inputted to the second task input section 200.

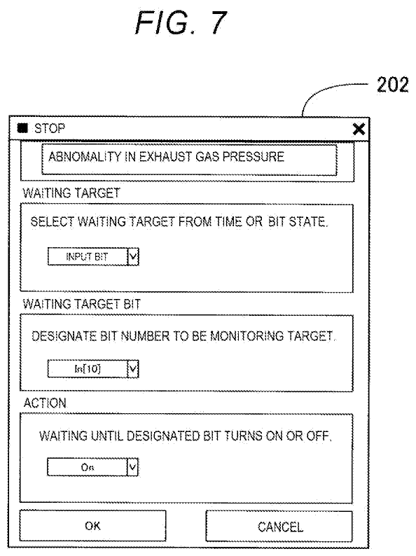

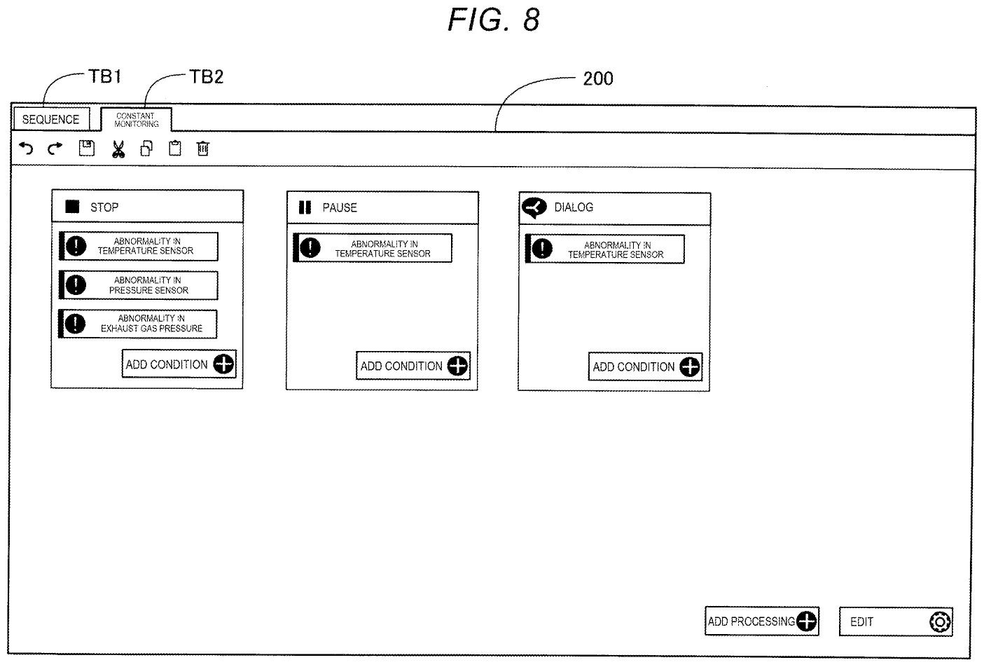

FIG. 7 is an explanatory view showing an example of the occurrence condition input section 202. FIG. 8 is an explanatory view showing an example of the second task input section 200 in the state where an occurrence condition is added. FIG. 8 shows the second task input section 200 in the state where an occurrence condition for “stop” is added from the state shown in FIG. 4. The occurrence condition input section 202 is displayed on the second task input section 200 in response to the selection by the user of an “add condition” button provided in the second task input section 200. In the occurrence condition input section 202, a pull-down input space is provided.

In the example shown in FIG. 7, the occurrence condition of an abnormality, “abnormality in exhaust gas pressure”, is inputted. In this example, when the signal inputted to the 10^{th} input port of the controller 60 is turned on, the occurrence condition of “abnormality in exhaust gas pressure” is met. The number or the like of the input port is inputted by the user via the input space provided in the occurrence condition input section 202. In response to the selection by the user of an “OK” button provided in the occurrence condition input section 202, the content of the occurrence condition inputted to the occurrence condition input section 202 is inputted to the second task input section 200. When a “cancel” button provided in the occurrence condition input section 202 is selected by the user, the content of the occurrence condition inputted to the occurrence condition input section 202 is discarded instead of being inputted to the second task input section 200. Preparing the second operation flow and inputting the occurrence condition of processing to implement the second operation flow causes the content of the second task to be inputted to the second task input section 200.

The above-described robot system 10 according to this embodiment enables the user to prepare multitasking program to execute the first task and the second task simultaneously and in parallel, simply by inputting the content of the first task via the first task input section 100 displayed on the display unit 51 and inputting the content of the second task via the second task input section 200. Therefore, even a user who is not skilled in preparing a program can easily prepare a multitasking program.

In this embodiment, a multitasking program to cause the robot 30 to successively execute a predetermined operation while constantly monitoring whether an abnormality has occurred in the injection molding machine 90 or not, and to stop the operation of the robot 30 or the like when it is determined that an abnormality has occurred, can be easily prepared.

In this embodiment, the second task input section 200 is configured to be able to input three kinds of processing, “stop”, “pause”, and “dialog”. Therefore, a multitasking program to execute these kinds of processing when it is determined that an abnormality has occurred, can be easily prepared.

### B. Other Embodiments

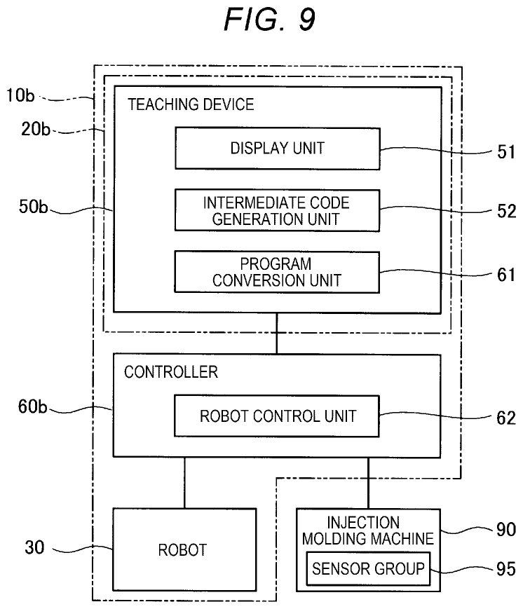

(B1) FIG. 9 is a block diagram showing a schematic configuration of a robot system 10b according to another embodiment. In the robot system 10b, the program conversion unit 61 is provided in a teaching device 50b instead of a controller 60b. A program preparation system 20b is formed solely of the teaching device 50b. Therefore, in some cases, the teaching device 50b is referred to as a program preparation device. The other parts of the configuration are the same as those in the first embodiment shown in FIG. 1.

(B2) In the robot systems 10, 10b according to the above embodiments, the second task is a task to constantly monitor whether an abnormality has occurred in the injection molding machine 90 or not during the execution of the first task and to cause the robot 30 or the like to implement a predetermined operation when it is determined that an abnormality has occurred. However, the second task may be a task to cause the injection molding machine 90 to implement a predetermined operation while the robot 30 is implementing a predetermined operation based on the execution of the first task. In this case, the occurrence condition input section 202 may not be provided in the second task input section 200.

(B3) In the robot systems 10, 10b according to the above embodiments, the second task input section 200 is configured to be able to input at least one of three kinds of processing, “stop”, “pause”, and “dialog”. However, the second task input section 200 may not be configured to be able to input “stop”, “pause”, and “dialog”. In this case, the second task input section 200 may be configured to be able to input other kinds of processing excluding “stop”, “pause”, and “dialog”.

### C. Other Aspects

The present disclosure is not limited to the above embodiments and can be implemented in various aspects without departing from the spirit and scope of the present disclosure. For example, the present disclosure can be implemented in the aspects described below. A technical feature in the embodiments corresponding to a technical feature in each of the aspects described below can be suitably replaced or combined in order to solve a part or all of the problems of the present disclosure or in order to achieve a part or all of the effects of the present disclosure. Also, the technical feature can be suitably deleted unless described as essential in this specification.

(1) According to a first aspect of the present disclosure, a program preparation system is provided. The program preparation system includes: a display unit displaying a first task input section to which a content of a first task to be executed by a target device is inputted and a second task input section to which a content of a second task to be executed by the target device is inputted, the second task being different from the first task; an intermediate code generation unit generating an intermediate code, using information inputted to the first task input section and information inputted to the second task input section; and a program conversion unit converting the intermediate code into a multitasking program causing the target device to execute the first task and the second task.

The program preparation system according to this aspect enables the user to prepare a multitasking program simply by inputting the content of the first task to the first task input section and inputting the content of the second task to the second task input section. Therefore, even a user who is not skilled in preparing a program can easily prepare a multitasking program.

(2) In the program preparation system according to the above aspect, the second task may be a task to constantly monitor whether an abnormality has occurred or not, and to cause the target device to execute predetermined processing when the abnormality has occurred. The second task input section may have an occurrence condition input section to which an occurrence condition indicating that the abnormality has occurred is inputted, and a processing content input section to which a content of the processing is inputted.

The program preparation system according to this aspect can easily prepare a multitasking program to execute the first task and the second task simultaneously and in parallel, the second task constantly monitoring whether an abnormality has occurred or not and executing predetermined processing when an abnormality has occurred.

(3) In the program preparation system according to the above aspect, the processing content input section may be configured to be able to input at least one of ending the first task, pausing the first task, and notification by a notification unit.

The program preparation system according to this aspect can easily prepare a multitasking program to execute the first task and the second task simultaneously and in parallel, the second task constantly monitoring whether an abnormality has occurred or not and executing at least one of ending the first task, pausing the first task, and notification by the notification unit when an abnormality has occurred.

(4) According to a second aspect of the present disclosure, a program preparation device is provided. The program preparation device includes: a display unit displaying a first task input section to which a content of a first task to be executed by a target device is inputted and a second task input section to which a content of a second task to be executed by the target device is inputted, the second task being different from the first task; an intermediate code generation unit generating an intermediate code, using information inputted to the first task input section and information inputted to the second task input section; and a program conversion unit converting the intermediate code into a multitasking program causing the target device to execute the first task and the second task.

The program preparation device according to this aspect enables the user to prepare a multitasking program simply by inputting the content of the first task to the first task input section and inputting the content of the second task to the second task input section. Therefore, even a user who is not skilled in preparing a program can easily prepare a multitasking program.

(5) According to a third aspect of the present disclosure, a robot system is provided. The robot system includes: a program preparation system including a display unit displaying a first task input section to which a content of a first task to be executed by a target device is inputted and a second task input section to which a content of a second task to be executed by the target device is inputted, the second task being different from the first task, an intermediate code generation unit generating an intermediate code, using information inputted to the first task input section and information inputted to the second task input section, and a program conversion unit converting the intermediate code into a multitasking program causing the target device to execute the first task and the second task; and a robot operating based on the multitasking program generated by the program preparation system.

The robot system according to this aspect enables the user to prepare a multitasking program simply by inputting the content of the first task to the first task input section and inputting the content of the second task to the second task input section. Therefore, even a user who is not skilled in preparing a program can easily prepare a multitasking program.

The present disclosure can be implemented in various other aspects than the program preparation system. For example, the present disclosure can be implemented in aspects such as a program preparation device and a robot system.

What is claimed is:

1. A program preparation system comprising:
a display unit displaying a first task input section to which a content of a first task to be executed by a target device is inputted and a second task input section to which a content of a second task to be executed by the target device is inputted, the second task being different from the first task;
an intermediate code generation unit generating an intermediate code, using information inputted to the first task input section and information inputted to the second task input section; and
a program conversion unit converting the intermediate code into a multitasking program causing the target device to execute the first task and the second task.

2. The program preparation system according to claim 1, wherein
the second task is a task to constantly monitor whether an abnormality occurs or not, and to cause the target device to execute predetermined processing when the abnormality occurs, and
the second task input section has an occurrence condition input section to which an occurrence condition indicating that the abnormality occurs is inputted, and a processing content input section to which a content of the processing is inputted.

3. The program preparation system according to claim 2, wherein
the processing content input section is configured to be able to input at least one of ending the first task, pausing the first task, and notification by a notification unit.

4. A program preparation device comprising:
a display unit displaying a first task input section to which a content of a first task to be executed by a target device is inputted and a second task input section to which a content of a second task to be executed by the target device is inputted, the second task being different from the first task;
an intermediate code generation unit generating an intermediate code, using information inputted to the first task input section and information inputted to the second task input section; and
a program conversion unit converting the intermediate code into a multitasking program causing the target device to execute the first task and the second task.

5. A robot system comprising:
the program preparation system according to claim 1; and
a robot operating based on the multitasking program generated by the program preparation system.
